(19) United States
(12) Patent Application Publication
(10) Pub. No.: US 2020/0152954 A1
(43) Pub. Date: May 14, 2020

(54) BATTERY CELL FOR AN ELECTRIC VEHICLE BATTERY PACK

(71) Applicant: SF Motors, Inc., Santa Clara, CA (US)

(72) Inventors: Scott Quinlan Freeman Monismith, Santa Clara, CA (US); Jeremy Elsberry, Santa Clara, CA (US); Derek Wong, Santa Clara, CA (US); Ying Liu, Santa Clara, CA (US); Yifan Tang, Santa Clara, CA (US); Raymond Kairawicz, Santa Clara, CA (US)

(21) Appl. No.: 16/190,018

(22) Filed: Nov. 13, 2018

(51) Int. Cl. H01M 2/34

(52) U.S. Cl. CPC H01M 2/347; H01M 2220/20

(57) ABSTRACT

A battery cell for an electric vehicle battery pack is provided. The battery cell can include a housing containing an electrolyte material and a first polarity terminal disposed at a lateral end of the battery cell. A current interrupt component can be disposed at the lateral end of the battery cell. The current interrupt component can include an inner portion electrically coupled with the first polarity terminal, an outer portion surrounding the inner portion and electrically coupled with the electrolyte material, a leg electrically coupling the inner portion with the outer portion. The leg can include a scored portion to tear in response to mechanical deformation of the battery cell and a fuse portion to melt in response to a threshold current within the battery cell.

### BACKGROUND

Electric vehicles such as automobiles can include on-board battery cells or battery packs to power the electric vehicles. Batteries can experience a condition such as thermal runaway under some operating conditions or environmental conditions.

### SUMMARY

At least one aspect of this disclosure is directed to a battery cell of a battery pack to power an electric vehicle. The battery cell can include a housing containing an electrolyte material. The battery cell can include a first polarity terminal disposed at a lateral end of the battery cell. The battery cell can include a current interrupt component disposed at the lateral end of the battery cell. The current interrupt component can include an inner portion electrically coupled with the first polarity terminal. The current interrupt component can include an outer portion surrounding the inner portion and electrically coupled with the electrolyte material. The current interrupt component can include a leg electrically coupling the inner portion with the outer portion. The leg can include a scored portion to tear in response to mechanical deformation of the battery cell and a fuse portion to melt in response to a threshold current within the battery cell.

At least one aspect of this disclosure is directed to a method of manufacturing battery cells for battery packs of electric vehicles. The method can include forming a housing for a battery cell of a battery pack having a plurality of battery cells. The housing can have a body region and a head region disposed at a lateral end of the battery cell. The method can include housing an electrolyte material within the housing for the battery cell. The method can include providing a current interrupt component comprising an inner portion, an outer portion surrounding the inner portion, and a leg electrically coupling the inner portion with the outer portion. The method can include etching a scoring pattern into the leg of the current interrupt component to cause the leg to tear in response to mechanical deformation of the battery cell. The method can include forming a fuse portion in the leg of the current interrupt component to cause the leg to melt in response to a threshold current within the battery cell. The method can include electrically coupling the inner portion of the current interrupt component with a first polarity terminal of the battery cell. The method can include electrically coupling the outer portion of the current interrupt component with the electrolyte material.

At least one aspect of this disclosure is directed to an electric vehicle. The electric vehicle can include a battery pack installed in the electric vehicle. The electric vehicle can include a battery cell in the battery pack. The battery cell can include a housing containing an electrolyte material. The battery cell can include a first polarity terminal disposed at a lateral end of the battery cell. The battery cell can include a current interrupt component disposed at the lateral end of the battery cell. The current interrupt component can include an inner portion electrically coupled with the first polarity terminal. The current interrupt component can include an outer portion surrounding the inner portion and electrically coupled with the electrolyte material. The current interrupt component can include a leg electrically coupling the inner portion with the outer portion. The leg can include a scored portion to tear in response to mechanical deformation of the battery cell and a fuse portion to melt in response to a threshold current within the battery cell.

At least one aspect of this disclosure is directed to a method. The method can include providing a battery cell of a battery pack to power an electric vehicle. The battery cell can include a housing containing an electrolyte material. The battery cell can include a first polarity terminal disposed at a lateral end of the battery cell. The battery cell can include a current interrupt component disposed at the lateral end of the battery cell. The current interrupt component can include an inner portion electrically coupled with the first polarity terminal. The current interrupt component can include an outer portion surrounding the inner portion and electrically coupled with the electrolyte material. The current interrupt component can include a leg electrically coupling the inner portion with the outer portion. The leg can include a scored portion to tear in response to mechanical deformation of the battery cell and a fuse portion to melt in response to a threshold current within the battery cell.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example battery cell for an electric vehicle battery pack, according to an illustrative implementation;

FIG. 2 depicts an example current interrupt component that can be used with a battery cell of an electric vehicle battery pack, according to an illustrative implementation;

FIG. 3 depicts an example insulating layer that can be used with a battery cell of an electric vehicle battery pack, according to an illustrative implementation;

FIG. 4 depicts an example top down view of a current interrupt component and an insulating layer arranged together, according to an illustrative implementation;

FIG. 5 depicts a cross-sectional view of a portion of a first example battery cell for an electric vehicle battery pack including a current interrupt component;

FIG. 6 depicts an example top down view of a current interrupt component and an insulating layer arranged together;

FIG. 7 depicts a cross-sectional view of a portion of a second example battery cell for an electric vehicle battery pack including a current interrupt component;

FIG. 8 is a block diagram depicting a cross-sectional view of an example battery pack for holding battery cells in an electric vehicle, according to an illustrative implementation;

FIG. 9 is a block diagram depicting a top-down view of an example battery pack for holding for battery cells in an electric vehicle, according to an illustrative implementation;

FIG. 10 is a block diagram depicting a cross-sectional view of an example electric vehicle installed with a battery pack, according to an illustrative implementation;

FIG. 11 depicts a flow chart of an example process undergone by a battery cell experiencing various conditions associated with thermal runaway, according to an illustrative implementation;

FIG. 12 depicts a flow chart of an example process of manufacturing a battery cell for a battery pack of an electric vehicle, according to an illustrative implementation; and

FIG. 13 depicts a flow chart of an example process of providing a battery cell for a battery pack of an electric vehicle, according to an illustrative implementation.

Following below are more detailed descriptions of various concepts related to, and implementations of battery cells for battery packs of electric vehicles, and methods, apparatuses, and systems to improve the performance of the battery cells. The various concepts introduced above and discussed in greater detail below may be implemented in any of numerous ways, as the described concepts are not limited to any particular manner of implementation.

### DETAILED DESCRIPTION

Systems and methods described herein relate to improving the performance of battery cells for battery packs that can provide power to electric vehicles (“EVs”). Battery packs, which can be referred to herein as battery modules, can include lithium ion battery cells. Lithium ion batteries perform well under normal operating conditions. However, certain abuse or out of tolerance range conditions can lead to the failure of lithium ion batteries. For example, when a battery cell is abused thermally, electrically, or mechanically, the battery cell has the potential to undergo a thermal runaway condition. During thermal runaway, reactions occurring on the surface of a negative electrode, also referred to as an anode, of the battery can cause heat generation, which in turn can accelerate the rate of the reaction, thereby creating a feedback loop that can result in rapid temperature acceleration of the battery. In some instances, this feedback loop can cause a battery cell failure.

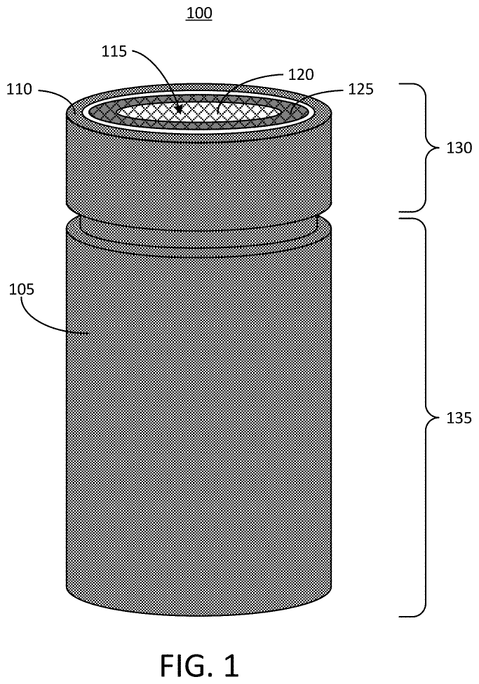

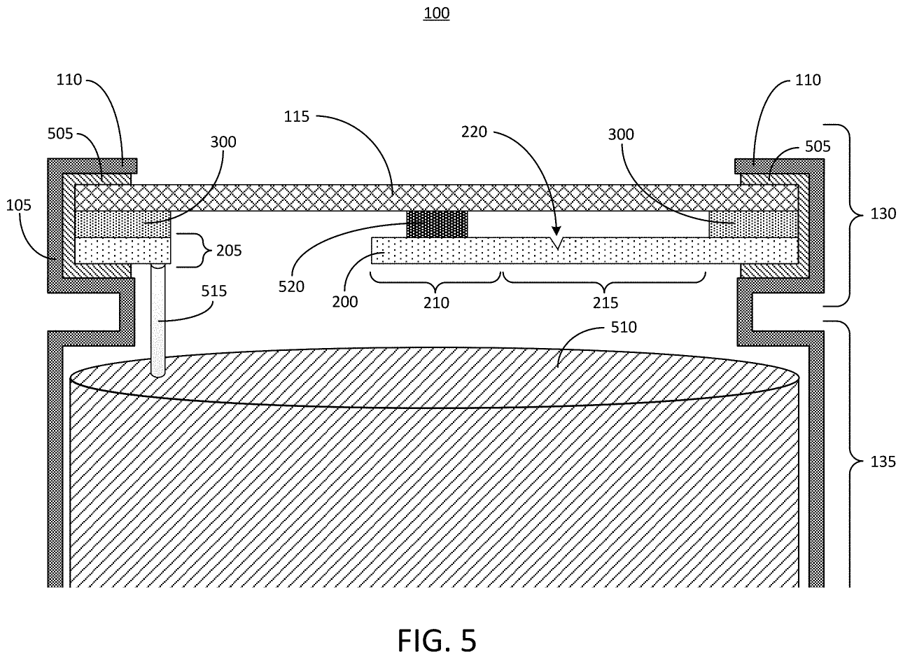

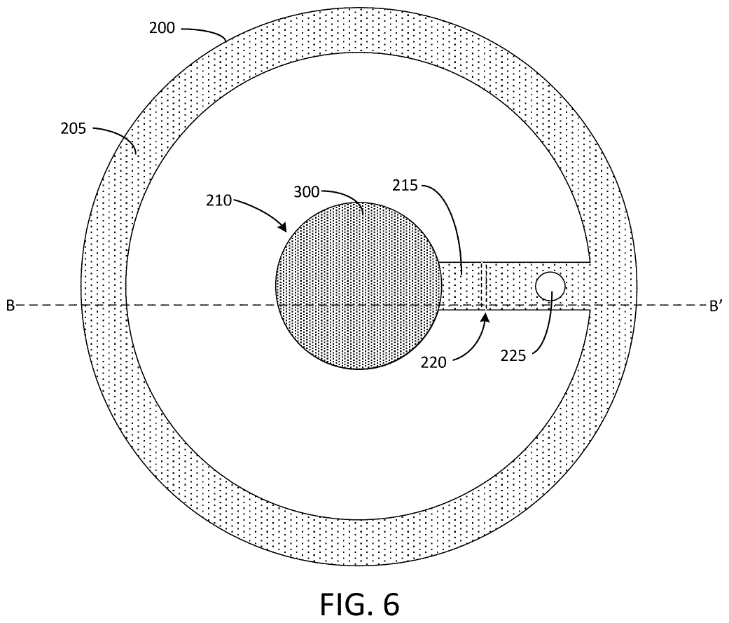

FIG. 1 depicts an example battery cell 100 for an electric vehicle battery pack. The battery cell 100 includes a housing 105. The housing includes a head portion 130 and a body portion 135. The head portion 130 is positioned at a lateral end of the battery cell 100 that is opposite the body portion 135. The body portion of the housing 105 can contain an electrolyte material or “jelly roll” that provides electric power. The electrolyte material is shown and described in connection with FIGS. 5 and 6, for example. The housing 105 can be electrically insulated from a positively charged portion of the electrolyte material and can be electrically coupled to a negatively charged portion of the electrolyte material to allow the housing 105 to serve as a negative terminal of the battery cell 100. For example, the housing 105 can be formed from a conductive metal, such as steel, aluminum, or copper.

The top perimeter edge of the housing 105 includes a lip 110, which can serve as the negative terminal and can be electrically coupled to a negative portion of the electrolyte material contained within the housing 105. Another portion of the upper surface of the battery cell 100 can serve as a positive terminal 115. The positive terminal 115 can have a flat planar shape across its surface. The positive terminal 115 also can have a non-planar shape. For example, the positive terminal 115 can include an upper surface 120 and a lower surface 125. The upper surface 120 (which can be referred to herein as a “table top”) of the positive terminal 115 can be positioned at a height above the height of the lip 110 (e.g., by 1-3 millimeters). The lower surface 125 of the positive terminal 115 can be recessed into the housing 105. For example, the lower surface 125 of the positive terminal 115 can be positioned at a height 1-3 millimeters below the height of the lip 110. The polarities of the positive terminal 115 and a negative terminal (e.g., a portion of the housing 105 such as the lip 110) also can be interchanged. For example, the positive terminal 115 may instead serve as a negative terminal, which can be coupled with a negative portion of the electrolyte material contained within the housing 105. The terms “positive” and “negative” polarities as used in this disclosure are exemplary only, and may be interchanged in some implementations.

Thermal runaway in the battery cell 100 can be preceded by an increase in any combination of gas pressure, temperature, or electric current in the region beneath the positive terminal 115 of the battery cell 100, which can be referred to herein as a cap. Built-in caps for battery cells such as the battery cell 100 can include a lid or cap having one or more vents to release gas pressure buildup within the battery cell 100. For example, the lid can respond to an internal pressure by rupturing or buckling away from the electrolyte material housed within the housing 105 when the pressure reaches or exceeds an activation threshold, thereby disconnecting or otherwise interrupting the flow or electric current. When pressure builds up beyond the activation threshold of the lid, the vents can rupture, allowing gas to escape, thereby relieving the pressure. However, while such a lid can respond to pressure increases that may indicate that thermal runaway is imminent, the lid does not directly respond to electrical current increases that can also signal the onset of thermal runaway. In addition, such a lid may exhibit a delayed response in cutting off current during a short circuit. For example, because such a lid responds to pressure rather than current, the rupturing or buckling of the lid to cut off current may not occur when the current initially increases during a short circuit, but rather is delayed until the short circuit causes a buildup of pressure. Such a lid also may be unable to respond to a mechanical crushing event by stopping the flow of current in the battery cell 100.

The battery cell 100 and its various components described herein provide solutions that can respond to at least two types of stimuli (e.g., mechanical crushing and high electrical current) that can be associated with thermal runaway, to mitigate consequences of out-of-tolerance range thermal events in the battery cell 100. For example, the battery cell 100 described herein can incorporate a current interrupt component and an insulating layer, which together can respond to mechanical stress or crushing as well as high current levels at pre-determined appropriate thresholds to interrupt the flow of current within the battery cell 100 when any one of those pre-determined thresholds is reached. The thresholds for each of these stimuli can be selected based on levels that may indicate the onset of thermal runaway. The thresholds also may correspond to any requirements or standards that may be used, for example, by industry groups or government entities. For example, the thresholds can be selected based on homologation standards or regulations, such as those set forth in Section 38.3 of the United Nations Manual of Tests and Criteria.

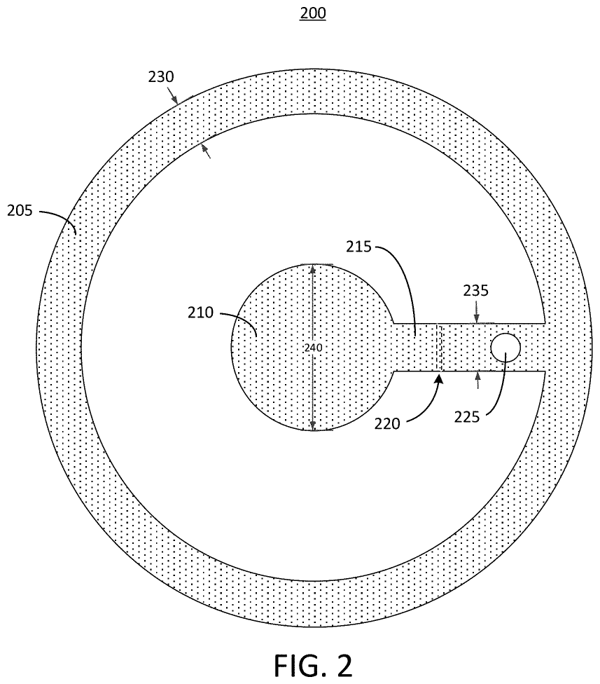

FIG. 2 depicts an example current interrupt component 200 that can be used with a battery cell of an electric vehicle battery pack, such as the battery cell 100 shown in FIG. 1. The current interrupt component 200 is shown in a top down view in FIG. 2. The current interrupt component 200 can respond to a high electrical current stimulus or mechanical crushing that may precede a thermal runaway event by severing an electrical current path within the battery cell 100, thereby halting or preventing the chemical reactions that may occur during thermal runaway. The current interrupt component 200 includes an outer portion 205, an inner portion 210, and a leg 215.

The current interrupt component 200 can have a shape that matches, dovetails with, or is similar to the cross-sectional shape of the housing 105. For example, in instances in which the housing 105 is cylindrical with circular cross sections, the current interrupt component 200 can be circular as depicted in FIG. 2. Stated differently, the outer portion 205 of the current interrupt component 200 may be circular to align with the perimeter of the cylindrical housing 105. The current interrupt component 200 may also have a different shape. For example, the outer portion 205 of the current interrupt component 200 can be elliptical, oval, triangular, square, hexagonal, octagonal, or any other suitable shape, which may or may not be similar to the cross-sectional shape of the housing 105. The outer portion 205 of the current interrupt component 200 can be symmetrical or asymmetrical.

The current interrupt component 200 can be planar. For example, the outer portion 205, the inner portion 210, and the leg 215 can all be flat components that lie within a common plane. The inner portion 210 of the current interrupt component 200 can be surrounded by or positioned within the outer portion 205 of the current interrupt component 200. The inner portion 210 can be concentric with the outer portion 205, as depicted in FIG. 2. The inner portion 210 also can be arranged in other positions with respect to the outer portion 205, such that a center of the inner portion 210 may be offset from a center of the outer portion 205. Thus, the inner portion 210 of the current interrupt component 200 may not be concentric with the outer portion 205 of the current interrupt component 200.

The inner portion 210 can have a shape that matches or is similar to the shape of the outer portion 205. For example, both the inner portion 210 and the outer portion 205 of the current interrupt component 200 can be circular. The inner portion 210 can also have a shape that is different from the shape of the outer portion 205. For example, the inner portion 210 may be triangular, rectangular, or hexagonal, while the outer portion 205 may be circular. The inner portion 210 may be configured for attachment (e.g., via a spot weld) to a portion of a vent plate. Thus, the inner portion 210 of the current interrupt component 205 may be configured to have a shape that matches, dovetails with, or is similar to a shape of the portion of the vent plate to which it will be bonded. Either or both of the inner portion 210 and the outer portion 205 of the current interrupt component 200 may have a symmetrical shape. For example, either or both of the inner portion 210 and the outer portion 205 of the current interrupt component 200 may exhibit radial symmetry. Either or both of the inner portion 210 and the outer portion 205 of the current interrupt component 200 may also have an asymmetrical shape. For example, the outer portion 205 may have a symmetrical shape, such as a circle, while the inner portion 210 has an asymmetrical shape.

The leg 215 couples the outer portion 205 with the inner portion 210 of the current interrupt component 200. For example, the leg 215 extends inwards from the outer portion 205 to the inner portion 210 of the current interrupt component 200. A length of the leg 215 can depend in part on the shape and size of the inner portion 210 and the outer portion 205 of the current interrupt component 200. For example, the leg 215 can extend along the shortest path (e.g., a straight line) between the inner portion 210 and the outer portion 205 of the current interrupt component 200, such that the length of the leg 215 is equal to the distance between inner portion 210 and the outer portion 205 of the current interrupt component 200. The leg may also have a non-linear shape. For example, the leg 215 can have curved edges or may follow a circuitous path.

Under normal operating conditions, the current interrupt component 200 can provide an electrical path for current to flow between the electrolyte material within the housing 105 and the positive terminal 115 of the battery cell 100. For example, the leg 215 can electrically couple the outer portion 205 of the current interrupt component 200 with the inner portion 210 of the current interrupt component 200. The current path between the electrolyte material and the positive terminal 115 of the battery cell 100 can pass from the inner portion 210, through the leg 215, to the outer portion 205. The current path between the electrolyte material and the positive terminal 115 of the battery cell 100 can also pass in the opposite direction (e.g., from the outer portion 205, through the leg 215, to the inner portion 210). Thus, the leg 215 can serve to carry electrical current in either direction between the outer portion 205 of the current interrupt component 200 and the inner portion 210 of the current interrupt component 200.

When the current inside the battery cell 100 reaches a threshold value (e.g., a value that may be indicative of thermal runaway) or when the battery cell 100 is subjected to crushing or other mechanical deformation, the leg 215 can be configured to tear, sever, melt, or otherwise deform in a manner that disconnects the current path between the inner portion 210 and the outer portion 205 of the current interrupt component 200. The leg 215 can include various features to facilitate this functionality. For example, the leg 215 can include a scored portion 220, which can be or can include one or more scoring marks, scoring lines, or scoring patterns. The scored portion 220 can be configured to intentionally weaken at least a portion of the material of the leg 215 in the vicinity of the scored portion 220, to facilitate tearing or rupturing of the leg 220 in the event that mechanical stress within the battery cell 100 reaches a threshold value.

The scored portion 220 can define one or more seems on the leg 215 of the current interrupt component 200, and the leg 215 can tear or break along these seems in response to mechanical stress, such as mechanical stress that occurs as a result of the battery cell 100 being crushed. The scored portion 220 can include one or more scoring marks arranged in a linear pattern, a circular pattern, a star-shaped pattern, a hatched pattern, a symmetrical or asymmetrical pattern, or any other pattern configured to facilitate tearing or breaking of the leg 215 in response to a predetermined mechanical stress threshold. The scored portion 220 can be formed, for example, by removing some of the material of the leg 215. For example, the scored portion 220 can include a partial cutting, etching, ablation, or other removal of some of the material that forms the leg 215. Thus, a thickness of the scored portion 220 may be less than a thickness of the remainder of the leg 215. For example, the scored portion 220 may have a thickness of less than 10%, less than 20%, less than 30%, less than 40%, less than 50%, less than 60% less than 70%, less than 80%, or less than 90% of the thickness of a remainder (e.g., a non-scored portion) of the leg 215.

The mechanical stress threshold selected to cause tearing or breaking of the leg 215 at the scored portion 220 can be based at least in part on a percentage of deformation of the battery cell 100. For example, the scored portion 220 can be selected to cause the leg 215 to break when the battery cell 100 deforms by at least 30%. Stated differently, the scoring pattern 220 can be selected to cause the leg 215 to break when the battery cell 100 is crushed or otherwise subjected to an external force such that its height is reduced by at least 30%. The scored portion 220 can also be selected to cause the leg 215 to break at other deformation thresholds of the battery cell 100. For example, the scored portion 220 can be selected to cause the leg 215 to break when the battery cell 100 deforms by at least 5%, at least 10%, at least 15%, at least 20%, at least 25%, at least 35%, at least 40%, at least 45%, at least 50%, at least 55%, at least 60%, at least 65%, at least 70%, at least 75%, or more.

The leg 215 can also include one or more holes 225. The hole 225 can be any opening, aperture, perforation, or other absence of material that forms an opening along at least a portion of the leg 215. The leg 215 can serve as part of a current path within the battery cell 100. As current passes through leg 215, the temperature of the leg 215 can rise due to resistive heating. The effects of resistive heating can be inversely proportional to the cross-sectional area of the leg 215. As a result, the leg 215 can experience a larger amount of resistive heating in region where the hole 225 is formed, because the cross-sectional area of the leg 215 in this region is smaller due to the removal of material to form the hole 225. This can allow the leg 215 to serve as a fuse. In particular, the hole 225 can define a fuse region of the leg 215 that can be configured to melt or otherwise break due to resistive heating in response to a threshold current level passing through the leg 215. Because the leg 215 serves as a portion of the current path for the battery cell 100, the current level at which the leg melts or breaks can be an upper limit for current flowing in the battery cell 100.

The current level at which the fuse region breaks can depend on a size of the hole 225 relative to the size of the leg 215. The hole 225 can be selected to have a size such that a distance between an edge of the hole 225 and an outer edge of the leg 215 is between 0.05 millimeters and 1.0 millimeters. For example, the hole 225 can be selected to have a size such that a distance between an edge of the hole 225 and an outer edge of the leg 215 is 0.1 millimeters, 0.15 millimeters, 0.2 millimeters, 0.25 millimeters, 0.3 millimeters, 0.35 millimeters, 0.4 millimeters, 0.45 millimeters, 0.5 millimeters, 0.55 millimeters, 0.6 millimeters, 0.65 millimeters, 0.7 millimeters, 0.75 millimeters, 0.8 millimeters, 0.85 millimeters, 0.9 millimeters, 0.95 millimeters, or 1.0 millimeters.

In some example, the hole 225 can have a shape or position that differs from that shown in FIG. 2. For example, the hole 225 can be circular as depicted in FIG. 2, or may have a different shape such as an elliptical shape, a triangular shape, a rectangular shape, a square shape, a hexagonal shape, or an octagonal shape. The hole 225 can also have an irregular or non-polygonal shape. The hole 225 can be spaced away from the scored portion 220 of the leg 215. The hole 225 can be centered between opposing edges of the leg 215, or may be offset from the center of the leg 215. In some examples, the hole 225 may at least partially overlap with the scored region 220. For example, the scored region 220 may include one or more scoring marks formed along an edge of the hole 225.

The threshold current that triggers the fuse portion of the leg 215 to melt or break can be in a range between 10 A and 100 A. For example, the threshold current that triggers the fuse portion of the leg 215 to melt or break can be between 40 A and 75 A or between 50 A and 70 A. The threshold current that triggers the fuse portion of the leg 215 to melt or break can also have other values or ranges, such as 10 A, 20 A, 30 A, 40 A, 50 A, 60 A, 70 A, 80 A, 90 A, or 100 A. The threshold current that triggers the fuse portion of the leg 215 to melt or break can also be less than 10 A or greater than 100 A.

The current interrupt component 200 can be formed from a rigid material, such as a metal or a rigid polymer. The current interrupt component 200 can be used to carry electrical current. Thus, the current interrupt component 200 can be formed from an electrically conductive material, such as aluminum, copper, or steel. The outer portion 205 of the current interrupt component 200 can have a diameter (e.g., a diameter across the entire current interrupt component 200) in the range of 12 millimeters to 25 millimeters. For example, the current interrupt component 200 can have a diameter of 12 millimeters, 13 millimeters, 14 millimeters, 15 millimeters, 16 millimeters, 17 millimeters, 18 millimeters, 19 millimeters, 20 millimeters, 21 millimeters, 22 millimeters, 23 millimeters, 24 millimeters, or 25 millimeters. In some examples, the outer portion 205 of the current interrupt component 200 can have a diameter between 15 millimeters and 23 millimeters.

The outer portion 205 of the current interrupt component 200 can have a width 230 in the range of 0.5 millimeters to 10 millimeters. For example, the outer portion 205 of the current interrupt component 200 can have a width 230 of 0.5 millimeters, 1 millimeter, 1.5 millimeters, 2 millimeters, 2.5 millimeters, 3 millimeters, 3.5 millimeters, 4 millimeters, 4.5 millimeters, 5 millimeters, 5.5 millimeters, 6 millimeters, 6.5 millimeters, 7 millimeters, 7.5 millimeters, 8 millimeters, 8.5 millimeters, 9 millimeters, 9.5 millimeters, or 10 millimeters. In some examples, the outer portion 205 of the current interrupt component 200 can have a width 230 in the range of 1 millimeter to 6 millimeters.

The inner portion 210 of the current interrupt component 200 can have a diameter 240 in the range of 1 millimeter to 10 millimeters. For example, the inner portion 210 of the current interrupt component 200 can have a diameter 240 of 1 millimeter, 1.5 millimeters, 2 millimeters, 2.5 millimeters, 3 millimeters, 3.5 millimeters, 4 millimeters, 4.5 millimeters, 5 millimeters, 5.5 millimeters, 6 millimeters, 6.5 millimeters, 7 millimeters, 7.5 millimeters, 8 millimeters, 8.5 millimeters, 9 millimeters, 9.5 millimeters, or 10 millimeters. In some examples, the inner portion 210 of the current interrupt component 200 can have a diameter 240 in the range of 4 millimeters to 8 millimeters.

The leg 215 of the current interrupt component 200 can have a width 235 in the range of 0.5 millimeters to 5 millimeters. For example, the leg 215 of the current interrupt component 200 can have a width 235 of 0.5 millimeters, 1 millimeter, 1.5 millimeters, 2 millimeters, 2.5 millimeters, 3 millimeters, 3.5 millimeter, 4 millimeters, 4.5 millimeters, or 5 millimeters.

The thickness of the current interrupt component 200 can be in the range of 0.1 millimeters to 1 millimeter. For example, the thickness of the current interrupt component 200 can be 0.1 millimeters, 0.2 millimeters, 0.3 millimeters, 0.4 millimeters, 0.5 millimeters, 0.6 millimeters, 0.7 millimeters, 0.8 millimeters, 0.9 millimeters, or 1 millimeter. In some examples, the thickness of the current interrupt component 200 can be in the range of 0.2 millimeters to 0.5 millimeters. The thickness of the current interrupt component 200 may be uniform or substantially uniform across an entirety of the current interrupt component 200, excluding the scored region 220 which may be thinner. For example, the thickness of the current interrupt component 200 may vary by less than 10% or less than 5% across its entire surface excluding the scored region 220. Other dimensions for the various features of the current interrupt component 200 are also possible.

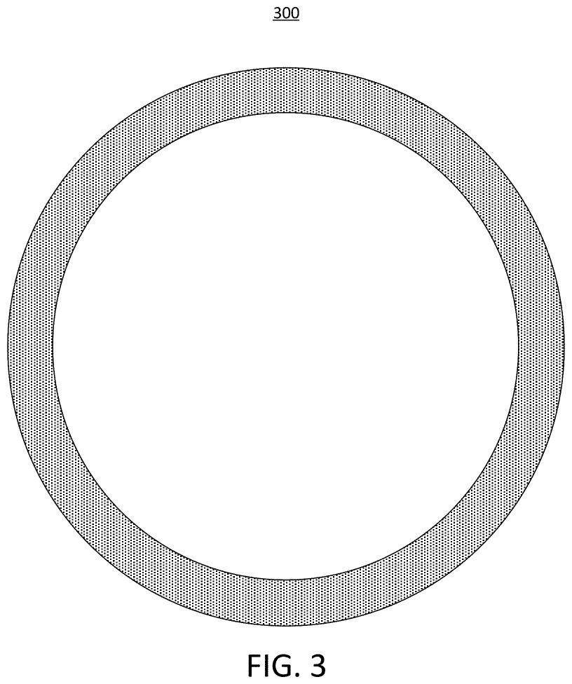

FIG. 3 depicts an example insulating layer 300 that can be used with a battery cell of an electric vehicle battery pack, such as the battery cell 100 of FIG. 1. The insulating layer 300 can also be used in conjunction with the current interrupt component 200. The insulating layer 300 can be configured to electrically insulate at least a portion of the current interrupt component 200 from at least a portion of the positive terminal 115 of the battery cell 100. For example, the insulating layer 300 can be configured to electrically insulate the outer portion 205 of the current interrupt component 200 from a vent plate or other device that forms at least a portion of the positive terminal 100 or is otherwise electrically coupled with the positive terminal 100.

The insulating layer 300 can therefore have dimensions that correspond to those of the outer portion 205 of the current interrupt component 200. For example, the insulating layer 300 can have a shape similar to the shape of the outer portion 205 of the current interrupt component 200, as well as a diameter and width matching those of the outer portion 205 of the current interrupt component 200. Thus, in examples in which the outer portion 205 of the current interrupt component 200 is circular, the insulating layer 300 can also be circular. The insulating layer 300 can have a diameter in the range of 12 millimeters to 25 millimeters. For example, the insulating layer 300 can have a diameter of 12 millimeters, 13 millimeters, 14 millimeters, 15 millimeters, 16 millimeters, 17 millimeters, 18 millimeters, 19 millimeters, 20 millimeters, 21 millimeters, 22 millimeters, 23 millimeters, 24 millimeters, or 25 millimeters. In some examples, the insulating layer 300 can have a diameter between 15 millimeters and 23 millimeters.

The insulating layer 300 can have a width in the range of 0.5 millimeters to 10 millimeters. For example, the insulating layer 300 can have a width of 0.5 millimeters, 1 millimeter, 1.5 millimeters, 2 millimeters, 2.5 millimeters, 3 millimeters, 3.5 millimeters, 4 millimeters, 4.5 millimeters, 5 millimeters, 5.5 millimeters, 6 millimeters, 6.5 millimeters, 7 millimeters, 7.5 millimeters, 8 millimeters, 8.5 millimeters, 9 millimeters, 9.5 millimeters, or 10 millimeters. In some examples, the insulating layer 300 can have a width in the range of 1 millimeter to 6 millimeters.

The insulating layer 300 can be formed from an electrically insulating material, such as polymer, a glass, or a ceramic material. The insulating layer 300 can also be or can include a material having adhesive properties such that the insulating layer 300 can be secured to the current interrupt component 200. For example, the insulating layer 300 can be applied to a surface of the outer portion 205 of the current interrupt component 200 as a coating. The coating can be applied using any form of deposition technique, such as spray coating of a polymer or other insulating material in liquid or vapor form. The liquid or vapor polymer can then be cured to form a solid layer that serves as the insulating layer 300.

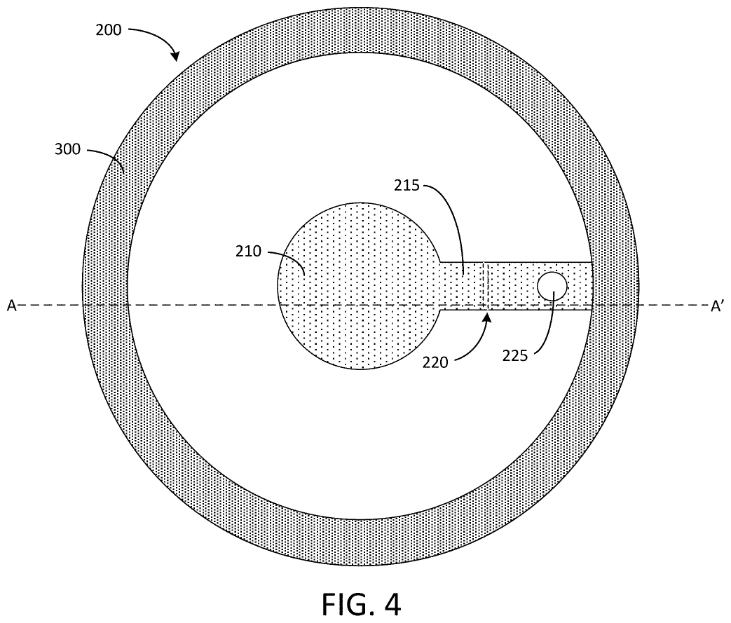

FIG. 4 depicts an example top down view of the current interrupt component 200 and the insulating layer 300 arranged together. The current interrupt component 200 and the insulating layer 300 can be arranged concentrically such that the insulating layer 300 overlaps or covers the outer portion 205 of the current interrupt component 200. In this arrangement, at least some of the current interrupt component 200 remains exposed. For example, at least part of the inner portion 210 and the leg 215 of the current interrupt component 200 may not be covered by the insulating layer 300. As a result, these portions of the current interrupt component 200 are available to form electrical connections with other components of the battery cell 100, such as the electrolyte material contained within the housing 105. In some examples, portions of the current collector 200 that are shown as exposed through the insulating layer 300 may instead be covered by the insulating layer 300. For example, a portion or an entirety of the leg 215 may also be covered by the insulating layer 300. A portion of the inner portion 210 also can be covered by the insulating layer 300.

The current interrupt component 200 and the insulating layer 300 can also be arranged such that their centers are offset from one another. For example, the current interrupt component 200 and the insulating layer 300 can be arranged in any manner that allows the insulating layer 300 to overlap or cover the outer portion 205 of the current interrupt component 200 so that the outer portion 205 of the current interrupt component 200 can be electrically insulated from other components on at least one side by the insulating layer 300. The insulating layer 300 can also be applied to only some areas of the outer portion 205 of the current interrupt component 200, while other areas of the outer portion 205 remain exposed. For example, instead of a closed ring of material as depicted in FIGS. 3 and 4, the insulating layer 300 can be applied to the outer portion 205 of the current interrupt component 200 in a discontinuous manner such that some areas of the outer portion 205 of the current interrupt component 200 would remain visible in the top down view of FIG. 4 (i.e., some areas of the outer portion 205 of the current interrupt component 200 could be unobstructed by the insulating layer 300).

FIG. 5 depicts a cross-sectional view of a portion of a first example battery cell 100 for an electric vehicle battery pack. The battery cell 100 incorporates a current interrupt component 200 and an insulating layer 300. The current interrupt component 200 and the insulating layer 300 are positioned in the arrangement shown in FIG. 4. The view depicted in FIG. 5 shows the cross-section of the current interrupt component 200 and the insulating layer 300 along the line A-A′ shown in FIG. 4. For illustrative clarity, some portions of the battery 100 are not visible in FIG. 6. The current interrupt component 200 and the insulating layer 300 are positioned in the head region 130 of the housing 100, along with the positive terminal 115. The positive terminal 115 can be or can include a vent plate that can be configured to rupture in the event of high pressure within the battery cell 100. A gasket 505 surrounds the current interrupt component 200, the insulating layer 300, and the positive terminal 115.

The gasket 505 can electrically insulate the current interrupt component 200 and the positive polarity terminal 115 from other components of the battery cell 100, such as the housing 105. The gasket 505 also can secure the current interrupt component 200 and the positive polarity terminal 115 within the head region 130 of the housing 105. The gasket 505 can also form a portion of a seal that seals the electrolyte material 510 within the housing 105 and separates the electrolyte material 510 from the external environment. The housing 105 can be crimped over the edge of the gasket 505, as depicted in FIG. 5, to define the lip 110 of the battery cell 100. The lip 110 can serve as a negative terminal of the battery cell 100. The current interrupt component 200, the positive polarity terminal 115, the gasket 605, and the housing 105 can all be crimped together in a single crimping operation or can be crimped separately through separate crimping operations.

The battery cell 100 can also be formed without the gasket 505. The positive terminal 115, the insulating layer 300, and the current interrupt component 205 can be secured to the housing in a different manner, such as via a glass weld. This can eliminate the need for a crimping operation. In addition, a glass weld can form the seal that seals the electrolyte material 510 inside the housing 105.

The outer portion 205 of the current interrupt component 200 can be electrically coupled with the electrolyte material 510 housed within the battery cell 100, for example by the conductive member 515. The conductive member 515 can be any type of member capable of forming an electrical connection between the outer portion 205 of the current interrupt component 200 and the electrolyte material 510. The conductive member 515 can be formed from a conductive metal, such as aluminum, copper, or steel. The conductive member 515 can also be formed from a conductive polymer or any other type of material capable of conducting electricity between the electrolyte material 510 and the outer portion 205 of the current interrupt component 200. The conductive member 515 can be a conductive wire or other element that is fixed to each of the electrolyte material 510 and the outer portion 205 of the current interrupt component 200, for example via one or more spot welds, mechanical fasteners, or electrically conductive adhesives.

The insulating layer 300 covers the outer portion 205 of the current interrupt component 200, thereby electrically insulating the outer portion 205 of the current interrupt component 200 from the positive terminal 115. The positive terminal 115 is electrically coupled with the inner portion 210 of the current interrupt component 200 via a spot weld 520. As a result of this arrangement, under normal operating conditions in which thermal runaway does not occur, electrical current can flow from the electrolyte material 510 to the outer portion 205 of the current interrupt component 200, through the leg 215 to the inner portion 210 of the current interrupt component 200, and then through the spot weld 520 to the positive terminal 115. Thus, for current to flow from the electrolyte material 510 within the housing 105 to the positive terminal 115, it must pass through the leg 215 of the current interrupt component 200.

When any combination of a threshold mechanical stress or a threshold electrical current is experienced within the battery cell 100 (e.g., due to a mechanical crushing or a thermal runaway event), the leg 215 of the current interrupt component 200 can tear, melt, rupture, or otherwise break such that the current path from the electrolyte material 510 to the positive terminal 115, which runs through the leg 215, becomes severed. For example, if the battery cell 100 experiences a threshold level of mechanical stress or a threshold level of deformation, the scored region 220 of the leg 215 of the current interrupt component 200 can become torn. If the battery cell 100 experiences a threshold level of electrical current, the fuse region formed by the hole 225 of the current interrupt component 200 can melt. Thus, in either case, the leg 215 can become severed and therefore the electrical path from the electrolyte material 510 to the positive terminal 115 becomes broken. As a result, current ceases to flow in the battery cell 100, and thermal runaway can be halted or prevented.

FIG. 6 depicts an example top down view of a current interrupt component 200 and an insulating layer 300 arranged together. The insulating layer 300 of FIG. 6 differs from that of FIG. 4 in that the insulating layer 300 of FIG. 6 is configured to overlap with the inner portion 210 of the current interrupt component 200, rather than the outer portion 205. Thus, the insulating layer 300 of FIG. 6 can have dimensions selected to correspond to those of the inner portion 210 of the current interrupt component 200. For example, the insulating layer 300 can have a circular shape with a diameter that matches the diameter of the inner portion 210 of the current interrupt component 200. The insulating layer 300 can have a diameter in the range of 1 millimeter to 10 millimeters. For example, the insulating layer 300 can have a diameter of 1 millimeter, 1.5 millimeters, 2 millimeters, 2.5 millimeters, 3 millimeters, 3.5 millimeters, 4 millimeters, 4.5 millimeters, 5 millimeters, 5.5 millimeters, 6 millimeters, 6.5 millimeters, 7 millimeters, 7.5 millimeters, 8 millimeters, 8.5 millimeters, 9 millimeters, 9.5 millimeters, or 10 millimeters. In some examples, the insulating layer 300 can have a diameter in the range of 4 millimeters to 8 millimeters

In this arrangement, at least some of the current interrupt component 200 remains exposed. For example, the outer portion 205 and the leg 215 of the current interrupt component 200 may not be covered by the insulating layer 300. As a result, these portions of the current interrupt component 200 are available to form electrical connections with other components of the battery cell 100, such as the electrolyte material 510 contained within the housing 105. In some examples, portions of the current collector 200 that are shown as exposed through the insulating layer 300 may instead be covered by the insulating layer 300. For example, a portion or an entirety of the leg 215 may also be covered by the insulating layer 300. A portion of the outer portion 205 also can be covered by the insulating layer 300.

The current interrupt component 200 and the insulating layer 300 can also be arranged such that their centers are offset from one another. For example, the current interrupt component 200 and the insulating layer 300 can be arranged in any manner that allows the insulating layer 300 to overlap or cover the inner portion 210 of the current interrupt component 200 so that the inner portion 210 of the current interrupt component 200 can be electrically insulated from other components on at least one side by the insulating layer 300. The insulating layer 300 can also be applied to only some areas of the inner portion 210 of the current interrupt component 200, while other areas of the inner portion 210 remain exposed. For example, instead of a closed disc of material that fully covers the inner portion 210 of the current interrupt component 200 as depicted in FIG. 6, the insulating layer 300 can be applied to the inner portion 210 of the current interrupt component 200 in a discontinuous manner such that some areas of the inner portion 210 of the current interrupt component 200 would remain visible in the top down view of FIG. 6 (i.e., some areas of the inner portion 210 of the current interrupt component 200 could be unobstructed by the insulating layer 300).

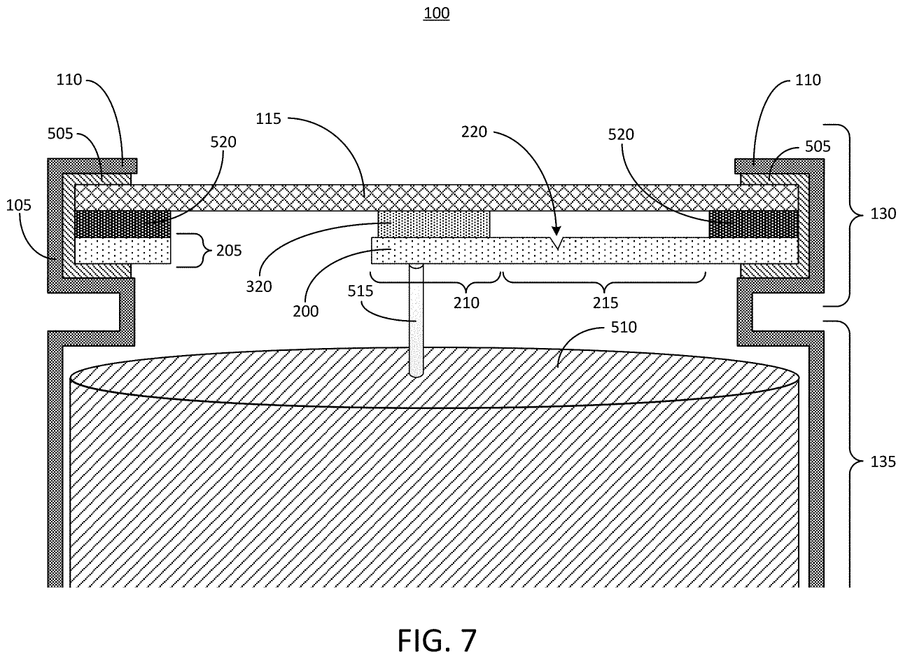

FIG. 7 depicts a cross-sectional view of a portion of a second example battery cell 100 for an electric vehicle battery pack. The battery cell 100 incorporates a current interrupt component 200 and an insulating layer 300. The current interrupt component 200 and the insulating layer 300 are positioned in the arrangement shown in FIG. 6. The view depicted in FIG. 5 shows the cross-section of the current interrupt component 200 and the insulating layer 300 along the line B-B′ shown in FIG. 6. The current interrupt component 200 and the insulating layer 300 are positioned in the head region 130 of the housing 100, along with the positive terminal 115.

The gasket 505 surrounds the current interrupt component 200, the insulating layer 300, and the positive terminal 115. The gasket 505 can electrically insulate the current interrupt component 200 and the positive polarity terminal 115 from other components of the battery cell 100, such as the housing 105. The gasket 505 also secures the current interrupt component 200 and the positive polarity terminal 115 within the head region 130 of the housing 105 and forms a portion of the seal that seals the electrolyte material 510 within the housing 105 and separates the electrolyte material 510 from the external environment. Similar to the arrangement shown in FIG. 5, the housing 105 in FIG. 7 can be crimped over the edge of the gasket 505 to define the lip 110 of the battery cell 100. The battery cell 100 can also be formed without the gasket 505. For example, the positive terminal 115, the insulating layer 300, and the current interrupt component 205 can be secured to the housing in a different manner, such as via a glass weld. This arrangement can eliminate the need for a crimping operation. In addition, a glass weld can form the seal that seals the electrolyte material 510 inside the housing 105.

The inner portion 210 of the current interrupt component 200 can be electrically coupled with the electrolyte material 510 housed within the battery cell 100, for example by the conductive member 515. The conductive member 515 can be any type of member capable of forming an electrical connection between the inner portion 210 of the current interrupt component 200 and the electrolyte material 510. The insulating layer 300 covers the inner portion 210 of the current interrupt component 200, thereby electrically insulating the inner portion 210 of the current interrupt component 200 from the positive terminal 115. The positive terminal 115 is electrically coupled with the outer portion 205 of the current interrupt component 200 via at least one spot weld 520. As a result of this arrangement, under normal operating conditions in which thermal runaway does not occur, electrical current can flow from the electrolyte material 510 to the inner portion 210 of the current interrupt component 200, through the leg 215 to the outer portion 205 of the current interrupt component 200, and then through the at least one spot weld 520 to the positive terminal 115. Thus, for current to flow from the electrolyte material 510 within the housing 105 to the positive terminal 115, it must pass through the leg 215 of the current interrupt component 200.

When any combination of a threshold mechanical stress or a threshold electrical current is experienced within the battery cell 100 (e.g., due to a mechanical crushing or a thermal runaway event), the leg 215 of the current interrupt component 200 can tear, melt, rupture, or otherwise break such that the current path from the electrolyte material 510 to the positive terminal 115, which passes through the leg 215, becomes severed. For example, a threshold level of mechanical stress or deformation can cause the scored region 220 of the leg 215 of the current interrupt component 200 to become torn. A threshold level of electrical current can cause the fuse region formed by the hole 225 of the current interrupt component 200 to melt. Thus, in either case, the electrical path from the electrolyte material 510 to the positive terminal 115 becomes broken when the leg 215 melts or tears due to its exposure to threshold levels of either or both of mechanical stress or electrical current. As a result, current ceases to flow in the battery cell 100, and thermal runaway can be halted or prevented.

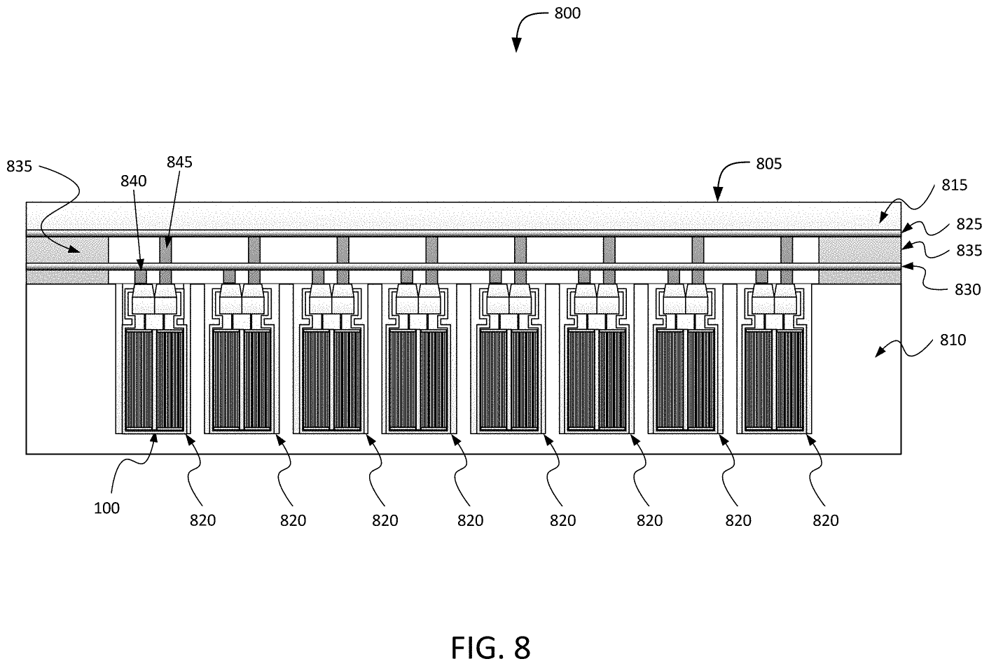

FIG. 8 depicts a cross-sectional view 800 of a battery pack 805 to hold a plurality of battery cells 100 in an electric vehicle. The battery pack 805 can include a battery module case 810 and a capping element 815. The battery module case 810 can be separated from the capping element 815. The battery module case 810 can include or define a plurality of holders 820. Each holder 820 can include a hollowing or a hollow portion defined by the battery module case 810. Each holder 820 can house, contain, store, or hold a battery cell 100. The battery module case 810 can include at least one electrically or thermally conductive material, or combinations thereof. The battery module case 810 can include one or more thermoelectric heat pumps. Each thermoelectric heat pump can be thermally coupled directly or indirectly to a battery cell 100 housed in the holder 820. Each thermoelectric heat pump can regulate temperature or heat radiating from the battery cell 100 housed in the holder 820. Bonding elements 850 and 855, which can each be electrically coupled with a respective one of the positive terminal 115 or a negative terminal (e.g., the lip 110 of the housing 105) of the battery cell 100, can extend from the battery cell 100 through the respective holder 820 of the battery module case 810.

Between the battery module case 810 and the capping element 815, the battery pack 805 can include a first busbar 825, a second busbar 830, and an electrically insulating layer 835. The first busbar 825 and the second busbar 830 can each include an electrically conductive material to provide electrical power to other electrical components in the electric vehicle. The first busbar 825 (sometimes referred to as a first current collector) can be connected or otherwise electrically coupled with the first bonding element 850 extending from each battery cell 100 housed in the plurality of holders 820 via a bonding element 845. The bonding element 845 can be bonded, welded, connected, attached, or otherwise electrically coupled with the bonding element 850. For example, the bonding element 845 can be welded onto a top surface of the bonding element 850. The second busbar 830 (sometimes referred to as a second current collector) can be connected or otherwise electrically coupled with the second bonding element 855 extending from each battery cell 100 housed in the plurality of holders 820 via a bonding element 840. The bonding element 840 can be bonded, welded, connected, attached, or otherwise electrically coupled with the second bonding element 855. For example, the bonding element 840 can be welded onto a top surface of the second bonding element 855. The second busbar 830 can define the second polarity terminal for the battery pack 805.

The first busbar 825 and the second busbar 830 can be separated from each other by the electrically insulating layer 835. The electrically insulating layer 835 can include spacing to pass or fit the first bonding element 850 connected to the first busbar 825 and the second bonding element 855 connected to the second busbar 830. The electrically insulating layer 835 can partially or fully span the volume defined by the battery module case 810 and the capping element 815. A top plane of the electrically insulating layer 835 can be in contact or be flush with a bottom plane of the capping element 815. A bottom plane of the electrically insulating layer 835 can be in contact or be flush with a top plane of the battery module case 810. The electrically insulating layer 835 can include any electrically insulating material or dielectric material, such as air, nitrogen, sulfur hexafluoride (SF₆), porcelain, glass, and plastic (e.g., polysiloxane), among others to separate the first busbar 825 from the second busbar 830.

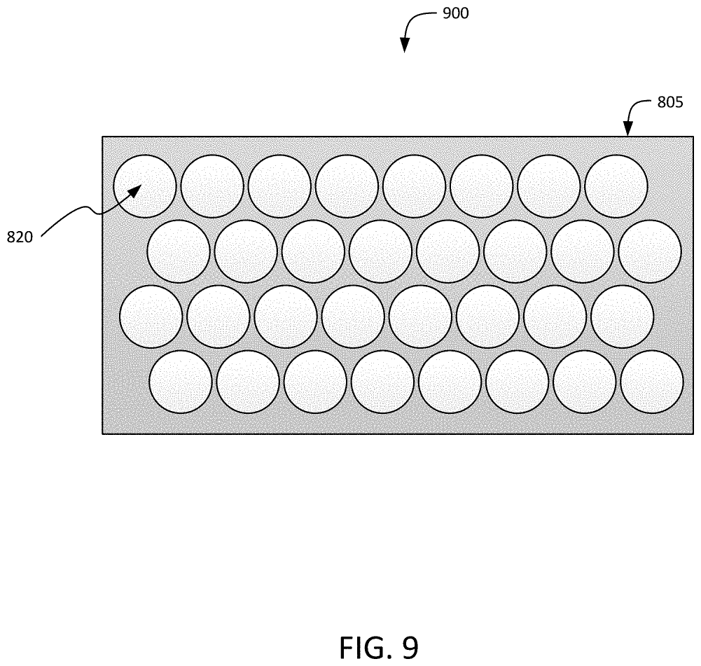

FIG. 9 depicts a top-down view 900 of a battery pack 805 to hold a plurality of battery cells 100 in an electric vehicle. The battery pack 805 can define or include a plurality of holders 820. The shape of each holder 820 can be triangular, rectangular, pentagonal, elliptical, and circular, among others. The shapes of each holder 820 can vary or can be uniform throughout the battery pack 805. For example, some holders 820 can be hexagonal in shape, whereas other holders can be circular in shape. The shape of the holder 820 can match the shape of a housing of each battery cell 100 contained therein. The dimensions of each holder 820 can be larger than the dimensions of the battery cell 100 housed therein.

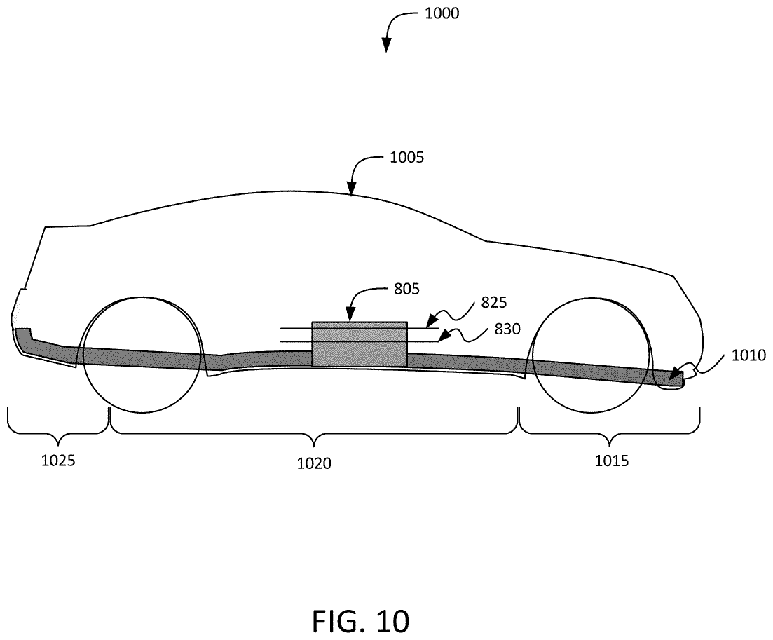

FIG. 10 depicts a cross-sectional view 1000 of an electric vehicle 1005 installed with a battery pack 805. The electric vehicle 1005 can include a chassis 1010 (sometimes referred to as a frame, internal frame, or support structure). The chassis 1010 can support various components of the electric vehicle 1005. The chassis 1010 can span a front portion 1015 (sometimes referred to a hood or bonnet portion), a body portion 1020, and a rear portion 1025 (sometimes referred to as a trunk portion) of the electric vehicle 1005. The battery pack 805 can be installed or placed within the electric vehicle 1005. The battery pack 805 can be installed on the chassis 1010 of the electric vehicle 1005 within the front portion 1015, the body portion 1020 (as depicted in FIG. 10), or the rear portion 1025. The first busbar 825 and the second busbar 830 can be connected or otherwise be electrically coupled with other electrical components of the electric vehicle 1005 to provide electrical power. The battery cells 100 referred to above in connection with FIGS. 8-10 may each include a current interrupt component 200 in order to respond to any combination of a threshold mechanical stress or deformation, or a threshold electrical current in the manner described above to halt or prevent thermal runaway events.

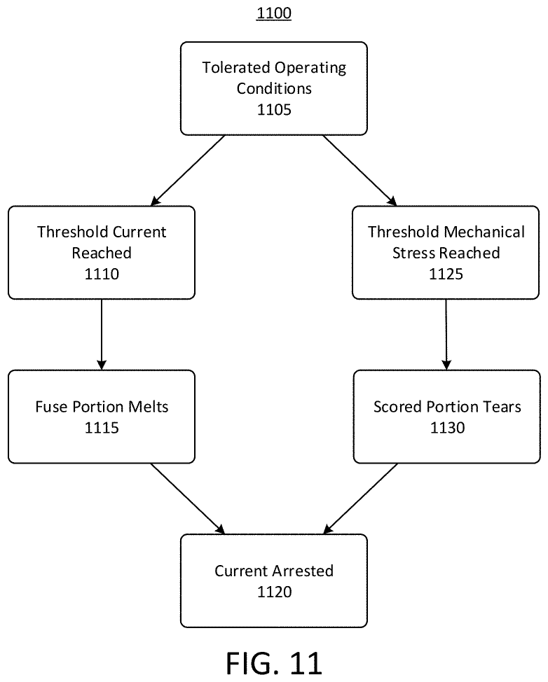

Referring now to FIG. 11 among others, the current interrupt component 200 can respond to threshold conditions of mechanical stress and electrical current, each of which may be indicative of an imminent or ongoing thermal runaway event for the battery cell 100. FIG. 11 depicts a flow chart of an example process 1100 undergone by a battery experiencing various conditions associated with thermal runaway. At block 1105, the battery cell 100 is operating under tolerated conditions. For example, tolerated conditions may include conditions under which the current within the battery cell 100 and the mechanical stress experienced by the battery cell 100 remain below specified threshold values.

In the event of a threshold current being reached within the battery cell 100, the process 1100 can proceed to block 1110. The threshold current can be any current known to indicate the onset of a thermal runaway event for the battery cell 100. The process 1100 can proceed to block 1115, in which the fuse portion of the current interrupt component 200 melts in response to the threshold current being reached. For example, the fuse portion can be formed by forming one or more holes 225 through the leg 215 of the current interrupt component 200, such that the fuse portion has a melting point that is reached via resistive heating effects occurring at the threshold current level reached in block 1110. Because the leg 215 of the current interrupt component 200 forms part of the current path from the electrolyte material 510 to the positive terminal 115 of the battery cell 100, melting of the fuse portion interrupts the current path and arrests this current, as indicated in block 1120 of the process 1100.

Referring again to block 1105, when a threshold level of mechanical stress occurs in the battery cell 100, the process 1100 can proceed to block 1125. The threshold mechanical stress can be any level of stress that may indicate the onset of a thermal runaway event for the battery cell 100. The threshold mechanical stress can also refer to a percentage of deformation experienced by the battery cell 100 as a result of mechanical stress, such as crushing. The process 1100 can proceed to block 1130 when the threshold level of mechanical stress is reached. In block 30 the scored portion 220 of the leg 215 of the current interrupt component 200 can become torn. This tearing of the scored portion 220 can break the electrical connection between the electrolyte material 510 to the positive terminal 115 of the battery cell 100, which initially relies on the intact leg 215 of the current interrupt component 200. As a result, the current path in the battery cell 100 can be broken. Thus, the current can be arrested in the battery cell 100, as indicated in block 1140 of the process 1100.

According to the process 1100, the current interrupt component 200 can respond to any combination of a threshold mechanical stress or a threshold electrical current occurring within the battery cell 100 by arresting the current. This represents a technical advancement in the field of battery protection devices. For example, battery protection devices may include thermal protection in the form of a device that responds to pressure or temperature within a battery cell 100. However, the root cause of failures that such devices are designed to respond to can be an external short circuit event during which a rapid external short circuit causes the battery cell 100 to rapidly overheat, generating both heat and pressure. Thus, electrical current (e.g., the short circuit) can be the initial cause, which then generates heat and pressure. If a battery cell 100 incorporates only a device that responds to heat and/or pressure, there could be a lag in response to a short circuit that would be best avoided by disconnecting the battery cell 100 from the circuit as soon as the short circuit current reaches a specified threshold. The current interrupt component 200 provides such functionality, while other battery protection devices do not. Thus, absent the improvements described herein, a battery cell 100 may be unable to respond adequately to a short circuit event that can coincide with thermal runaway.

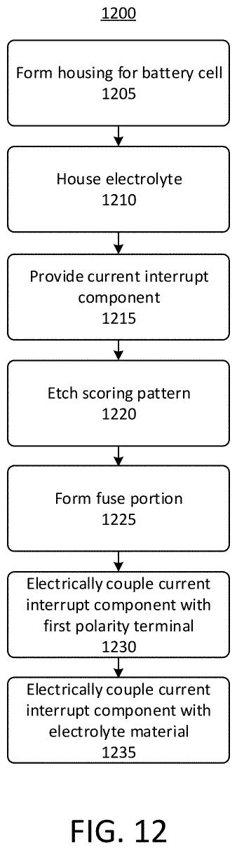

FIG. 12 depicts a flow chart of an example process 1200 of manufacturing a battery cell 100, according to an illustrative implementation. The process 1200 can include forming a housing 105 for the battery cell 100 of a battery pack having a plurality of battery cells (block 1205). The housing can have a body region 135 and a head region 130. The head region 130 can be disposed at a lateral end of the battery cell 100. The housing 105 can be formed, for example, from a structurally rigid material, such as aluminum or steel. The housing also can be formed from a conductive material. For example, forming the housing from a conductive material can allow at least a portion of the housing to serve as a terminal of the battery cell 100.

The process 1200 can include housing, within the body region 135 of the battery cell 100, an electrolyte material 510 (block 1210). The electrolyte material 510 can include at least one charged portion configured to provide electric power for the battery cell 100. In some examples, at least a portion of the electrolyte material 510 may be electrically isolated from the housing 105.

The process 1200 can include providing a current interrupt component 200 (block 1215). The current interrupt component 200 can include an inner portion 210 and an outer portion 205 surrounding the inner portion 210. The current interrupt component 200 can also include a leg 215 electrically coupling the inner portion 210 with the outer portion 205. Providing the current interrupt component 200 can include manufacturing the current interrupt component 200. For example, the current interrupt component 200 can be formed from a metal disc made from aluminum, steel, or copper. Forming the current interrupt component 200 can include stamping, punching, or otherwise removing some of the material of the disc to define the outer portion 205, the inner portion 210, and the leg 215. The current interrupt component 200 can be a substantially planar device. Thus, manufacturing the current interrupt component 200 may not require any bending or other deformation of the metal disc.

The process 1200 can include etching a scoring pattern into the leg 215 of the current interrupt component 200 (block 1220). For example, the scoring pattern can define a scored region 220 of the leg 215. The scored region 220 can be configured to cause the leg 215 to tear in response to mechanical deformation of the battery cell 100. The scored region 220 can include one or more scoring marks. The scoring marks can remove a portion of the material of the leg 215 to intentionally weaken the leg 215 in the scored region 220. For example, the scoring marks can include one or more etched valleys, troughs, or perforations formed in the leg 215.

The process 1200 can include forming a fuse portion in the leg 215 of the current interrupt component 200 (block 1225). The fuse portion can be configured to cause the leg 215 to melt in response to a threshold current within the battery cell 100. The fuse portion can be formed, for example, by removing a portion of the material that makes up the leg 215 of the current interrupt component 200. For example, forming the fuse portion in the leg 215 can include forming one or more holes 225 through the leg 215. The size of the one or more holes 225 relative to the size of the leg 215 can be selected based on the threshold current level at which the fuse portion should melt. For example, a larger hole 225 formed through the leg 215 can cause the leg 215 to melt in response to a relatively lower threshold current level. The hole 225 can be formed, for example, using a stamping or punching apparatus to bore the hole 225 through the leg 215. The hole 225 also can be formed in other ways, for example by laser ablation or by use of any other cutting or boring apparatus.

The process 1200 can include electrically coupling the inner portion 210 of the current interrupt component 200 with a first polarity terminal 115 of the battery cell 100 (block 1230). For example, the inner portion 210 can be electrically coupled with the first polarity terminal 115 via a spot weld. The inner portion 210 can also be electrically coupled with the first polarity terminal 115 by other means, such as an electrically conductive mechanical fastener or an electrically conductive adhesive material. Other regions of the current interrupt component 200, such as either or both of the outer portion 205 or the leg 215, can be electrically insulated from the first polarity terminal 115, for example by use of an insulating layer 300.

The process 1200 can include electrically coupling the outer portion 210 of the current interrupt component 200 with the electrolyte material 510 (block 1235). For example, the outer portion 205 can be electrically coupled with the first polarity terminal 115 via a conductive member 515. The conductive member 515 can be any type of member capable of forming an electrical connection between the outer portion 205 of the current interrupt component 200 and the electrolyte material 510. The conductive member 515 can be formed from a conductive metal, such as aluminum, copper, or steel. The conductive member 515 can also be formed from a conductive polymer or any other type of material capable of conducting electricity between the electrolyte material 510 and the outer portion 205 of the current interrupt component 200. The conductive member 515 can be a conductive wire or other element that is fixed to each of the electrolyte material 510 and to the outer portion 205 of the current interrupt component 200, for example via one or more spot welds, mechanical fasteners, or electrically conductive adhesives. The process 1200 can also include securing the first polarity terminal 115 and the current interrupt component 200 within the housing 105 via a gasket 505. The gasket 505 can also seal the electrolyte material 510 within the housing 105.

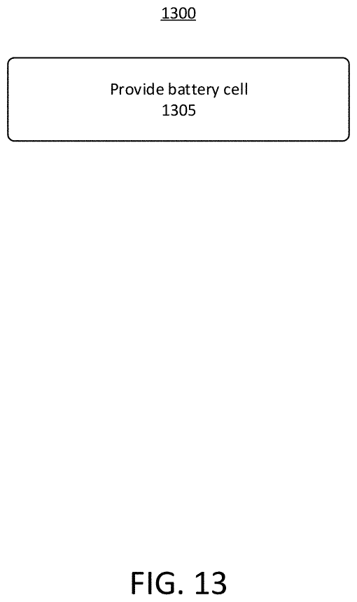

FIG. 13 depicts a flow chart of an example process 1300. The process 1300 can include providing a battery cell 100 (block 1305). For example, the battery cell 100 can be a battery cell of a battery pack 805 to power an electric vehicle 1005. The battery cell 100 can include a housing 105 containing an electrolyte material 510. The battery cell 100 can include a first polarity terminal 115 disposed at a lateral end of the battery cell 100. The battery cell 100 can include a current interrupt component 200 disposed at the lateral end of the battery cell 100. The current interrupt component 200 can include an inner portion 210 electrically coupled with the first polarity terminal 115. The current interrupt component 200 can include an outer portion 205 surrounding the inner portion 210 and electrically coupled with the electrolyte material 510. The current interrupt component 200 can include a leg 215 electrically coupling the inner portion 210 with the outer portion 205. The leg 215 can include a scored portion 220 to tear in response to mechanical deformation of the battery cell 100 and a fuse portion to melt in response to a threshold current within the battery cell 100.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A battery cell of a battery pack to power an electric vehicle, comprising:
a housing containing an electrolyte material;
a first polarity terminal disposed at a lateral end of the battery cell;
a current interrupt component disposed at the lateral end of the battery cell, the current interrupt component comprising:
an inner portion electrically coupled with the first polarity terminal;
an outer portion surrounding the inner portion and electrically coupled with the electrolyte material; and
a leg that electrically couples the inner portion with the outer portion, the leg comprising a scored portion to tear in response to mechanical deformation of the battery cell and a fuse portion to melt in response to a threshold current within the battery cell.

2. The battery cell of claim 1, comprising:
an insulating layer disposed between the outer portion of the current interrupt component and at least a portion of the first polarity terminal to electrically insulate the outer portion of the current interrupt component from the first polarity terminal.

3. The battery cell of claim 2, comprising:
the insulating layer including a polymer material.

4. The battery cell of claim 1, comprising:
a vent plate disposed at the lateral end of the battery cell and electrically coupled with the first polarity terminal, the inner portion of the current interrupt component electrically coupled with the vent plate.

5. The battery cell of claim 1, comprising:
a vent plate disposed at the lateral end of the battery cell and electrically coupled with the first polarity terminal, the inner portion of the current interrupt component spot welded to the vent plate.

6. The battery cell of claim 1, comprising:
a gasket formed from an electrically insulating material to seal the electrolyte material within the housing of the battery cell and to electrically insulate the housing from the current interrupt component.

7. The battery cell of claim 1, comprising:
the current interrupt component comprising aluminum.

8. The battery cell of claim 1, comprising:
a hole formed through the leg of the current interrupt component to form the fuse portion of the leg.

9. The battery cell of claim 8, comprising:
a distance between a perimeter of the hole and an outer edge of the leg of the current interrupt component between 0.1 millimeters and 0.5 millimeters.

10. The battery cell of claim 1, comprising:
the threshold current between 20 A and 80 A.

11. The battery cell of claim 1, comprising:
the outer portion of the current interrupt component having a diameter between 15 millimeters and 23 millimeters and a width between 1 millimeter and 6 millimeters.

12. The battery cell of claim 1, comprising:
the current interrupt component having a thickness between 0.2 millimeters and 0.5 millimeters.

13. The battery cell of claim 1, wherein:
the battery cell is part of a battery pack that includes a plurality of additional battery cells.

14. The battery cell of claim 1, wherein:
the battery cell is part of a battery pack that includes a plurality of additional battery cells disposed in an electric vehicle.

15. A method of providing battery cells for battery packs of electric vehicles, comprising:
forming a housing for a battery cell of a battery pack having a plurality of battery cells, the housing having a body region and a head region disposed at a lateral end of the battery cell;
housing an electrolyte material within the housing for the battery cell;
providing a current interrupt component comprising an inner portion, an outer portion surrounding the inner portion, and a leg electrically coupling the inner portion with the outer portion;
etching a scoring pattern into the leg of the current interrupt component to cause the leg to tear in response to mechanical deformation of the battery cell;
forming a fuse portion in the leg of the current interrupt component to cause the leg to melt in response to a threshold current within the battery cell;
electrically coupling the inner portion of the current interrupt component with a first polarity terminal of the battery cell; and
electrically coupling the outer portion of the current interrupt component with the electrolyte material.

16. The method of claim 15, comprising:
creating a hole in the leg of the current interrupt component to form the fuse portion of the leg.

17. The method of claim 15, comprising:
providing an insulating layer between the outer portion of the current interrupt component and at least a portion of the first polarity terminal to electrically insulate the outer portion of the current interrupt component from the first polarity terminal.

18. The method of claim 15, comprising:
spot welding the inner portion of the current interrupt component to the first polarity terminal to form an electrical connection between the current interrupt component and the first polarity terminal.

19. The method of claim 15, comprising:
coupling the first polarity terminal and the current interrupt component with the housing via a gasket to seal the electrolyte material within the housing

20. An electric vehicle, comprising:
a battery pack installed in the electric vehicle; and
a battery cell in the battery pack, comprising:
a housing containing an electrolyte material;
a first polarity terminal disposed at a lateral end of the battery cell;
a current interrupt component disposed at the lateral end of the battery cell, the current interrupt component comprising:
an inner portion electrically coupled with the first polarity terminal;
an outer portion surrounding the inner portion and electrically coupled with the electrolyte material; and
a leg electrically coupling the inner portion with the outer portion, the leg comprising a scored portion to tear in response to mechanical deformation of the battery cell and a fuse portion to melt in response to a threshold current within the battery cell.
